(19) United States
(12) Patent Application Publication
(10) Pub. No.: US 2009/0230843 A1
(43) Pub. Date: Sep. 17, 2009

(54) Electroluminescence Element

(76) Inventors: Joachim Krumpe, Brunnthal (DE); Carsten Otte, München (DE); Oliver Narwark, München (DE)

Correspondence Address: COLLARD & ROE, P.C., 1077 NORTHERN BOULEVARD, ROSLYN, NY, 11576, US

(21) Appl. No.: 11/887,047

(22) PCT Filed: Feb. 17, 2006
(86) PCT No.: PCT/EP2006/060069

§ 371 Date: Dec. 31, 2007

(30) Foreign Application Priority Data
Mar. 24, 2005 (EP) 05102372.9

(51) Int. Cl. H01J 1/62

(52) U.S. Cl. 313/504

(57) ABSTRACT

The invention relates to an electroluminescence element (1) comprising a light-permeable first electrode (4), a luminescence layer (5), a second electrode (7), and a protective laminate (8). The invention is characterised in that the protective laminate (8) has a water-vapour permeability of between 0.35 g/m2/24 h at 38° C. and 100% relative atmospheric humidity and 10 g/m2/24 h at 38° C. and 100% relative atmospheric humidity.

The invention relates to an electroluminescence element having a light-permeable first electrode, a luminescence layer, a second electrode, and a protective laminate.

A “protective laminate” is understood to be a protective layer that has a film that is laminated on, an imprinting, a varnish layer, or a composite material, possibly self-adhesive, having these components.

According to the state of the art (DE 103 21 152 A1), such electroluminescence elements were provided with a protective laminate that was as impermeable to water vapor as possible, in order to prevent the penetration of water vapor. Water vapor layers having a water vapor permeability rate of less than 0.005 g/m²/24 h at 38° C. and 100% relative humidity were proposed to protect the luminescence layer from moisture penetrating from the outside, in order to thereby achieve the greatest possible useful lifetime of the electroluminescence element.

The invention is based on the task of creating an electroluminescence element of the type stated initially, which is characterized by a long useful lifetime and period of operation.

This task is accomplished, in the case of the electroluminescence element stated initially, in that the protective laminate has a water vapor permeability in the range between 0.35 g/m²/24 h at 38° C. and 100% relative humidity and 10 g/m²/24 h at 38° C. and 100% relative humidity.

It was surprisingly found that the use of protective laminates that have a low water vapor permeability increase the useful lifetime of the electroluminescence elements. This surprising effect is probably attributable to the fact that a barrier layer that is permeable for water vapor within limits makes it possible for residual solvents and moisture that is absorbed by way of the carrier that is affixed to the electroluminescence element to exit, without putting the electroluminescence element at risk, and nevertheless effectively prevents the penetration of water vapor from the surroundings with sufficient effectiveness. In the case of very good vapor barrier layers, on the other hand, residual solvent and moisture absorbed by way of the carrier can exit from the system again only with very great difficulty. The use of a protective laminate having a water vapor permeability in the range between 0.35 g/m²/24 h at 38° C. and 100% relative humidity and 10 g/m²/24 h at 38° C. and 100% relative humidity has proven itself to be effective in this connection.

Preferably, a protective laminate is used that has a water vapor permeability in the range between 0.5 g/m²/24 h at 38° C. and 100% relative humidity and 5 g/m²/24 h at 38° C. and 100% relative humidity.

A protective laminate that has a water vapor permeability in the range between 0.8 g/m²/24 h at 38° C. and 100% relative humidity and 2.5 g/m²/24 h at 380° C. and 100% relative humidity has proven itself to be particularly advantageous.

The invention is suitable for electroluminescence elements in which the luminescence layer is an inorganic thick layer that can be activated by means of an electric alternating voltage.

The invention has led to particularly good results with regard to increasing the useful lifetime in the case of electroluminescence elements particularly if the electroluminescence elements are imprinted directly onto a plastic substrate, such as a light-permeable injection-molded part, for example.

The invention will be explained in greater detail below, using exemplary embodiments shown schematically in the drawings. The drawings are not true to scale. Instead, the thicknesses of the layers of the electroluminescence element are drawn greatly enlarged in comparison with the other dimensions.

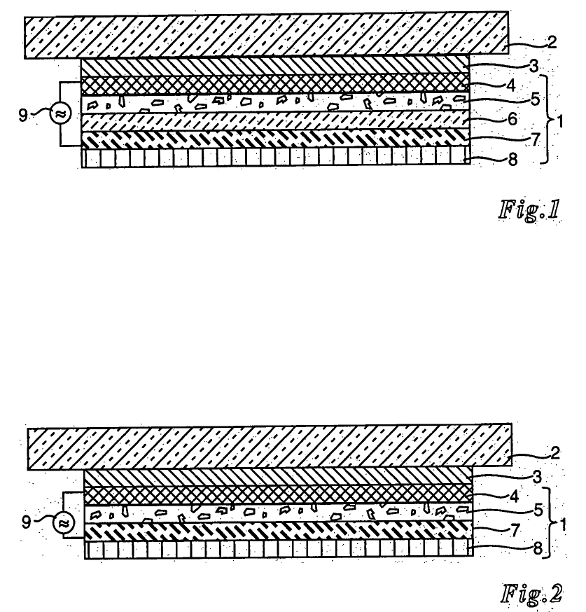

FIG. 1 shows a first embodiment of an electroluminescence element according to the invention, in a sectional representation;

FIG. 2 shows an embodiment variant of the embodiment according to FIG. 1.

FIG. 1 shows an electroluminescence element 1 according to the invention, which is affixed to a plastic carrier 2—in the example, onto a body of polycarbonate produced using the injection-molding method—by means of direct imprinting.

The electroluminescence element 1 has a transparent electrode layer 4, which is a printable conductive varnish. Alternatively to this, a layer of indium tin oxide (ITO) or antimony tin oxide can also be produced to form the electrode layer 4.

A luminescence layer 5 follows the electrode layer 4; in the example, the former is a thick layer that can be activated by means of alternating voltage. This layer has a binder matrix with embedded inorganic luminophores.

The luminescence layer 5 is followed by a dielectric 6. The latter is a layer of white ceramic particles that are characterized by a high dielectricity constant.

The dielectric 6 is covered by a conductive layer of silver, carbon, or varnish, for example, which forms the second electrode 7.

The composite structure is finally sealed with a laminate 8 that has a water vapor permeability in the range between 1.3 g/m²/24 h at 38° C. and 100% relative humidity and 1.9 g/m²/24 h at 38° C. and 100% relative humidity. The water vapor permeability is sufficiently small so that the composite is protected from penetrating moisture, and nevertheless allows solvent residues and gas evolution from the composite to exit.

The two electrodes 4 and 7 are electrically connected with an alternating voltage source 9, which makes an alternating voltage of 100 volts available, at a frequency of 400 Hz.

The electroluminescence element 1 is produced as follows:

First, a transparent layer 3 is applied to a transparent carrier 2, e.g. an injection-molded part, to impart adhesion and/or to improve the optical impression (e.g. using screen-printing or as a hard coat). Optionally, an improvement of this optical impression can also be achieved by means of additional ink layers, for example by means of a metal layer (graphic silver). To produce the transparent electrode 4, a layer of a transparent conductive varnish (here, conductors are preferably either polymer systems, e.g. doped polythiophenes, inorganic systems (ITO=indium tin oxide), or ATO=antimony tin oxide)) is imprinted on this, which layer functions as the transparent electrode 4. Electroluminophores embedded into a binder matrix are applied to this, using the screen-printing method, to form the luminescence layer 5. The dielectric 6 follows, which has a layer of white ceramic particles, which are also embedded in a binder matrix and applied using the screen-printing method. These particles are characterized by a high value of the dielectricity constant. In order to complete the capacitor system, another electrically conductive layer (e.g. of silver, carbon, conductive varnish) is applied, which represents the second electrode 7. The system is finished with an imprinted insulation layer (not shown), in order to protect the user from the alternating voltage to be applied (typically 100-160 V and 400-800 Hz), and to protect the electroluminescence element 1 from moisture.

Because of the low water vapor permeability of the protective laminate 8, the result is achieved that moisture that is absorbed by the light-permeable carrier 2 can exit via the protective laminate 8. Likewise, gas evolution and solvent residues can leave the composite without impairing the function of the electroluminescence element 1. At the same time, the protective laminate 8 represents an effective barrier against the entry of moisture.

FIG. 2 shows an exemplary embodiment of an electroluminescence element 1 in which no dielectric is provided. Since the remainder of the structure of the electroluminescence element 1 does not differ from that of the exemplary embodiment of FIG. 1, and the production methods are also the same—with the exception of leaving out the step for the production of the dielectric—a repeated description is not presented, in order to avoid repetition.

1. Electroluminescence element (1) having a light-permeable first electrode (4), a luminescence layer (5), a second electrode (7), and a protective laminate (8), wherein the protective laminate (8) has a water vapor permeability in the range between 0.35 g/m²/24 h at 38° C. and 100% relative humidity and 10 g/m²/24 h at 38° C. and 100% relative humidity.

2. Electroluminescence element (1) according to claim 1, wherein the protective laminate (8) has a water vapor permeability in the range between 0.5 g/m²/24 h at 38° C. and 100% relative humidity and 5 g/m²/24 h at 38° C. and 100% relative humidity.

3. Electroluminescence element (1) according to claim 1, wherein the protective laminate (8) has a water vapor permeability in the range between 0.8 g/m²/24 h at 38° C. and 100% relative humidity and 2.5 g/m²/24 h at 38° C. and 100% relative humidity.

4. Electroluminescence element (1) according to claim 1, wherein it has a dielectric layer (6).

5. Electroluminescence element (1) according to claim 1, wherein the luminescence layer (5) is a thick layer that can be activated by means of an electric alternating voltage (9).

6. Electroluminescence element (1) according to claim 1, wherein it has a metal layer (graphic silver).

7. Electroluminescence element (1) according to claim 1, wherein it is imprinted onto a plastic substrate (2).

8. Electroluminescence element (1) according to claim 7, wherein the plastic substrate (2) is an injection-molded substrate.

9. Electroluminescence element (1) according to claim 7, wherein the plastic substrate (2) is light permeable.

10. Electroluminescence element (1) according to claim 7, wherein the plastic substrate (2) contains polycarbonate.
